(19) United States
(12) Patent Application Publication
(10) Pub. No.: US 2024/0201139 A1
(43) Pub. Date: Jun. 20, 2024

(54) FLOW FIELD-FLOW FRACTIONATION DEVICE INCLUDING THICKNESS-TAPERED CHANNEL BLOCK

(71) Applicant: UIF (University Industry Foundation), Yonsei University, Seoul (KR)

(72) Inventors: Myeong Hee MOON, Gyeonggi-do (KR); Seung Yeon SHIN, Gyeonggi-do (KR); Jae Won SEO, Gyeonggi-do (KR)

(21) Appl. No.: 18/536,448

(22) Filed: Dec. 12, 2023

(30) Foreign Application Priority Data
Dec. 14, 2022 (KR) 10-2022-0174998

(51) Int. Cl. G01N 30/00

(52) U.S. Cl. CPC G01N 30/0005

(57) ABSTRACT

The present application relates to a flow field-flow fractionation device including a thickness-tapered channel block, and more particularly, to a flow field-flow fractionation device including a thickness-tapered channel block, capable of reducing separation time, improving sample recovery, and exhibiting a flow rate programming effect without a separate equipment, thereby allowing a size range of separation to be expanded.

### CROSS-REFERENCE TO RELATED APPLICATION

This application claims priority to and the benefit of Korean Patent Application No. 10-2022-0174998, filed on Dec. 14, 2022, the disclosure of which is incorporated herein by reference in its entirety.

### BACKGROUND

### 1. Field of the Invention

The present application relates to a flow field-flow fractionation device including a thickness-tapered channel block, and more particularly, to a flow field-flow fractionation device including a thickness-tapered channel block, capable of reducing separation time, improving sample recovery, and exhibiting a flow rate programming effect without a separate equipment, thereby allowing a size range of separation to be expanded.

### 2. Discussion of Related Art

Flow field-flow fractionation (FlFFF) is an elution-based analysis method capable of separating macromolecules by size. The analysis method is one example of the most popularly used field-flow fractionation (FFF) analysis methods because of various applications including synthetic polymers, proteins, extracellular vesicles, cells, and nano- to micron-sized particles.

Size-based fractionation in FlFFF is based on a differential distribution of sample components above a channel wall depending on their hydrodynamic diameters, as well as enforcement by crossflow moving across the channel wall.

When migration flow of a parabolic velocity pattern is applied to sample components that are in equilibrium between a force (crossflow) and opposing diffusional forces, submicron-sized particles or macromolecules elute in an increasing order of diameter, which is typical during elution in a normal operating mode of FFF.

However, particles larger than 1 μm in diameter elute in an opposite order of size since a contribution of particle diffusion is negligible but a role of hydrodynamic lift forces, which is referred to as steric/hyperlayer operation, is increased.

However, the diffusion does not play a significant role in an elution mechanism of particles larger than 1 μm in diameter. Such particles are driven to equilibrium positions close to the accumulation wall where a force due to an applied field or a movement of the fluid crossflow is balanced by opposing hydrodynamic lift forces.

While fluid inertial lift forces tend to drive particles away from walls bounding fluid flow, they are relatively weak and are often not strong enough to counter the applied forces. Experiments using sedimentation FFF have shown an effect of much stronger lift forces in a region close to the wall. The forces increase with particle diameter, the reciprocal of a distance between an entrained particle and the wall, and a fluid shear rate close to the wall.

The result is that equilibrium positions of the particles are generally quite close to the wall, and considering hydrodynamic effects that retard a particle velocity relative to an undisturbed fluid velocity at a position of the particle center, a migration velocity along a channel is determined. Diameter-based selectivity S_{d} (=d log tᵣ/d log d) tends to be less than 1 in sedimentation FFF in steric mode and greater than 1 in FlFFF in steric/hyperlayer mode.

When particulate or cellular species with a diameter range of 1 μm or less are analyzed, particles around a steric inversion diameter are eluted together, so complete separation in either the normal or steric/hyperlayer mode alone is difficult. The steric inversion diameter in FlFFF is typically observed in 0.4 to 0.7 μm for polystyrene (PS) latex beads.

The steric inversion diameter may be increased by decreasing hydrodynamic lift forces either by increasing channel thickness or by increasing a diffusional contribution by increasing temperature. The steric inversion diameter is increased up to 1.8 μm when the channel thickness is increased to 490 μm. This approach is useful for the size analysis of submicron-sized sample materials with a maximum diameter of approximately 1 to 2 μm. However, for particle samples with primary size distributions exceeding 1 μm, including some undersized (<1 μm) particles as a minor distribution, it is useful to shift steric inversion to a low submicrometer scale.

Such operation may be achieved by increasing hydrodynamic lift forces by decreasing the channel thickness or increasing a migration flow rate. For example, for PS latex, steric inversion is reduced to 0.23 μm or less by decreasing the channel thickness in FlFFF. However, when the channel thickness is decreased, there is a problem in that the size of an upper particle that is able to be separated is limited. Increasing the field strength may be an alternative to solve the problem, but the approach may increase the risk of loss of sample particles in the channel when the migration flow rate is not high, despite a simultaneous increase in the hydrodynamic lift forces for larger-diameter particles.

An approach for enlarging a dynamic size range of separation without sacrificing retention time for smaller particles and resolution for larger particles in the steric/hyperlayer mode is to employ a flow rate programming method in which either the crossflow rate decreases, or the migration flow rate increases with time. However, flow rate programming for FlFFF requires a special flow controller that may incur additional costs for system setup.

### SUMMARY OF THE INVENTION

The present invention is directed to providing a flow field-flow fractionation device including a thickness-tapered channel block, capable of reducing separation time, improving sample recovery, and exhibiting a flow rate programming effect without a separate equipment, thereby allowing a size range of separation to be expanded.

According to an aspect of the present invention, there is provided a flow field-flow fractionation channel block.

In one example, the flow field-flow fractionation channel block includes an inlet through which a fluid is introduced, an outlet through which the fluid is discharged, and a channel connecting the inlet and the outlet, and the channel is provided to have a thickness decreasing at least in part along a direction from the inlet to the outlet.

In one example, the channel may be provided to have a breadth decreasing at least in part along the direction from the inlet to the outlet.

In one example, the channel may include a first region having a breadth increasing at least in part along the direction from the inlet to the outlet, and a second region connected to the first region and having a decreasing breadth.

In one example, the second region may be provided so that the breadth linearly decreases.

In one example, the channel may further include a third region connecting a second region and the outlet and provided to have a breadth decreasing rate greater than a breadth decreasing rate of the second region.

In one example, the channel may be provided so that the thickness linearly decreases.

In one example, the channel block may be made of polycarbonate.

According to another aspect of the present application, there is provided a flow field-flow fractionation device.

In one example, the flow field-flow fractionation device includes a housing having an injection hole and a discharge hole, the flow field-flow fractionation channel block described above that is disposed within the housing and includes a channel for transferring a fluid introduced through the injection hole to the discharge hole, and a membrane layered above porous frit element in order to allow fluid movement across the channel underneath the plastic block of flow field-flow fractionation channel system.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram for describing a flow field-flow fractionation device in the related art;

FIG. 2 is a schematic diagram for describing a flow field-flow fractionation device according to one embodiment of the present application;

FIGS. 3A and 3B are schematic diagrams for describing channels formed in a block according to one embodiment of the present application and a block according to a comparative example;

FIG. 4 shows a top view and a side view of a block having a thickness-tapered shape according to one embodiment of the present application and a block having a thickness-uniform shape;

FIG. 5 is a schematic image of a measurement system using a flow field-flow fractionation device;

FIGS. 6 and 7 are graphs showing results of comparison of separation of PS standard mixtures, respectively, obtained with a thickness-uniform channel (w=300 μm) and a thickness-tapered channel (w=400→200 μm) under two different flow rate conditions in a steric/hyperlayer mode; (1) \dot{V}ₒᵤₜ/\dot{V}_{c}=3.0/0.5 mL/min and (2) \dot{V}ₒᵤₜ/\dot{V}_{c}=4.5/0.5 mL/min;

FIG. 8 is a result graph showing steric inversion diameter (di) values of the thickness-tapered channel and the thickness-uniform channel with log tᵣ (min) versus log d (μm) of PS standard particles; and

FIG. 9 is a graph comparing recovery rates for PS standard particles in the thickness-tapered channel and the thickness-uniform channel.

### DETAILED DESCRIPTION OF EXEMPLARY EMBODIMENTS

The terms used in the present application are merely provided to describe specific embodiments and are not intended to limit the present invention. The singular forms are intended to include the plural forms as well, unless the context clearly indicates otherwise. In the present specification, terms “including” and/or “having” are intended to merely specify the presence of features, components, and the like, described in the specification, but do not mean that one or more other features, components, and the like, do not exist or cannot be added.

Unless otherwise defined, all terms used herein, including technical or scientific terms, have the same meaning as commonly understood by those of ordinary skill in the art to which the present invention belongs. Terms, such as those defined in commonly used dictionaries, should be interpreted as having a meaning that is consistent with their meaning in the context of the related art and will not be interpreted in an idealized or overly formal sense unless expressly so defined herein.

In the present application, the term “nano” may mean a size in nanometers (nm), for example, a size of 1 to 1,000 nm, but is not limited thereto. In addition, the term “nanoparticles” in the present specification may mean particles having an average particle diameter in nanometers (nm), for example, particles having an average particle diameter of 1 to 1,000 nm but is not limited thereto.

Hereinafter, a flow field-flow fractionation channel block of the present application and a flow field-flow fractionation device including the same will be described in detail with reference to the attached drawings. However, the attached drawings are illustrative, and the scope of the flow field-flow fractionation channel block of the present application and the flow field-flow fractionation device including the same is not limited by the attached drawings.

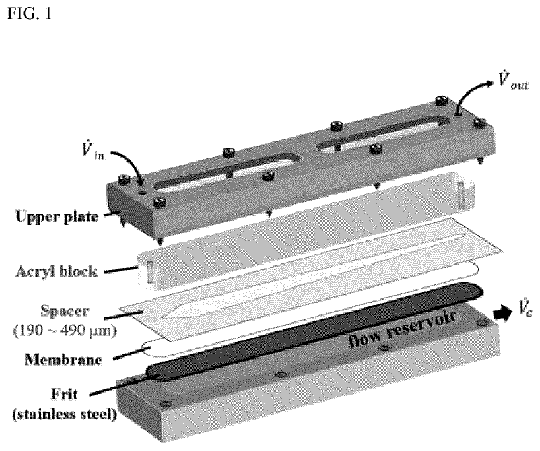

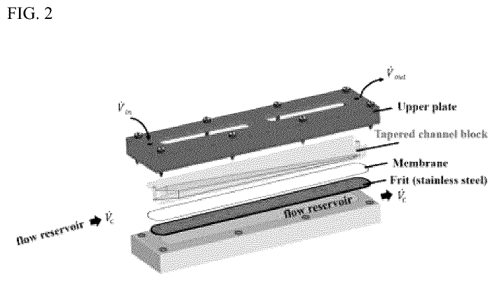

FIG. 1 is a schematic diagram for describing a flow field-flow fractionation device in the related art. In addition, FIG. 2 is a schematic diagram for describing a flow field-flow fractionation device according to one embodiment of the present application.

FIG. 1 shows the flow field-flow fractionation device in the related art, and for example, shows a device including a flow reservoir, a stainless steel (SS) frit, a membrane, a channel spacer, an acryl block, and an upper plate in a basic structure of conventional FlFFF channel system from Wyatt Technology. In contrast, unlike the flow field-flow fractionation device in the related art described above, the flow field-flow fractionation device according to one embodiment of the present application has a thickness-tapered channel which does not use the channel spacer constituting the volume of the channel, but instead may use the existing channel block as a channel block carved in a shape of decreasing thickness, which is shown in FIG. 2. In particular, the channel block is prone to bending when made of acrylic material, and thus it is preferable to make the channel block of polycarbonate having more robust properties. Here, the channel membrane may be a regenerated cellulose (RC) membrane that has excellent chemical resistance and a molecular weight cut-off (MWCO) of 10 kDa.

The flow field-flow fractionation channel block according to one embodiment of the present application includes an inlet through which a fluid is introduced, an outlet through which the fluid is discharged, and a channel connecting the inlet and the outlet, and the channel is provided to have a thickness decreasing at least in part along a direction from the inlet to the outlet.

In addition, the flow field-flow fractionation device according to one embodiment of the present application may include a housing having an injection hole and a discharge hole, a block disposed within the housing and including a channel for transferring a fluid introduced through the injection hole to the discharge hole, and a membrane layered above porous frit element in order to allow fluid movement across the channel underneath the plastic block of flow field-flow fractionation channel system, the block may have the inlet connected to the injection hole and the outlet connected to the discharge hole, the channel may connect the inlet and the outlet, and the channel may be provided to have a thickness decreasing at least in part along a direction from the inlet to the outlet.

As shown in FIG. 2, the upper plate refers to the housing. The injection hole is provided on one side of the housing, and the discharge hole is provided on the other side thereof.

In addition, a thickness-tapered channel block refers to the channel block. The flow field-flow fractionation device includes the channel block that is disposed within the housing and that includes a channel for transferring a fluid introduced through the injection hole to the discharge hole.

The flow field-flow fractionation device includes the membrane layered above porous frit element in order to allow fluid movement across the channel. The membrane may include a fluid permeable membrane.

In addition, any parts, devices, and the like that are able to be included in the flow field-flow fractionation device may be included in the flow field-flow fractionation device of the present application.

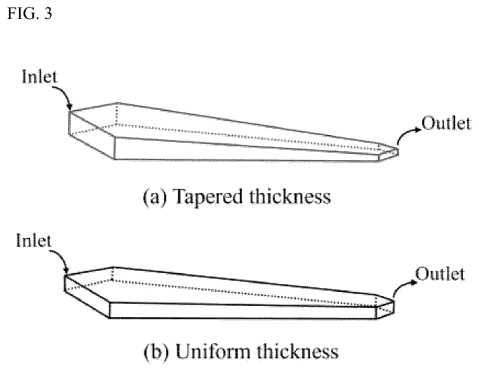

FIGS. 3A and 3B are schematic diagrams for describing channels formed in a block according to one embodiment of the present application and a block according to a comparative example.

A channel is a passage through which fluid moves. As shown in FIGS. 3A and 3B, it can be clearly confirmed that a channel of the block according to one embodiment of the present application has a change in thickness compared to the comparative example having a constant thickness.

As shown in FIGS. 2 to 3B, the block may have the inlet connected to the injection hole and the outlet connected to the discharge hole, the channel may connect the inlet and the outlet, and the channel may be provided to have the thickness decreasing at least in part along the direction from the inlet to the outlet.

In one example, the channel may be provided to have a breadth decreasing at least in part along the direction from the inlet to the outlet. That is, the breadth of the channel may gradually decrease in the direction toward the outlet.

In another example, the channel may include a first region having a breadth increasing at least in part along the direction from the inlet to the outlet and a second region connected to the first region and having a decreasing breadth. That is, the breadth of the channel may increase in a certain region and then decrease again in a certain region.

In still another example, the second region may be provided so that the breadth linearly decreases.

In yet another example, the channel may further include a third region connecting the second region and the outlet and provided to have a breadth decreasing rate greater than a breadth decreasing rate of the second region. That is, the breadth of the channel may increase in a certain region and then decrease again in a certain region, and a region where more significantly decreases to a greater degree of decrease, that is, at a greater decreasing rate, may be included therein.

In still yet another example, the channel may be provided so that the breadth linearly decreases.

In one example, the channel may be made of polycarbonate.

Hereinafter, the present application will be described in more detail through an experimental example.

### EXPERIMENTAL EXAMPLE

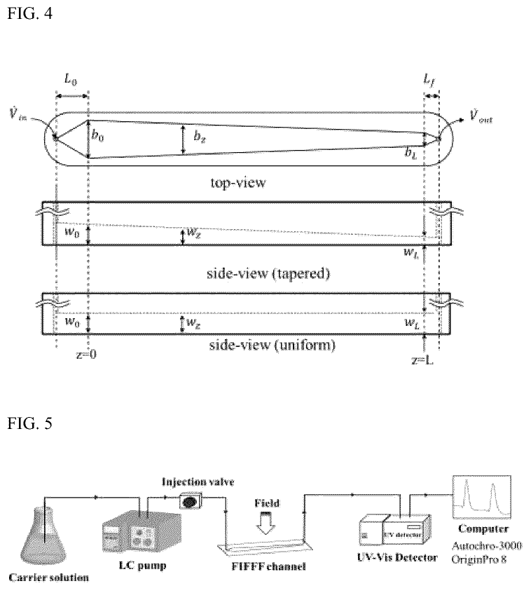

FIG. 4 shows a top view and a side view of a block having a thickness-tapered shape according to one embodiment of the present application and a block having a thickness-uniform shape.

For both the block with the thickness-tapered channel and the block with the thickness-uniform channel, a surface where the membrane touches is a typical ribbon shape like the channel spacer, but when viewed from the side, the thickness-tapered channel block is designed to have a thickness that is deepest at the inlet and becomes shallower toward the outlet. On the other hand, the thickness-uniform channel block is constructed by carving the inside thereof to a constant thickness and has an effective channel volume similar to that of the thickness-tapered channel block.

For a channel space engraved on the channel block, a length from the inlet to the outlet (tip to tip) when viewed from above is 26.6 cm, each of a breadth b₀ and a length L₀ in a triangle in an inflow direction are 2.1 cm, and each of a breadth b_{L} and a length L_{f} in a triangle in an outflow direction is 0.6 cm. In the present application, a thickness-tapered channel block of 400 to 200 μm (w₀=380 μm, w_{L}=205 μm) and a thickness-uniform channel block of 300 μm (w₀=w_{L}=300 μm) were produced and results thereof were compared.

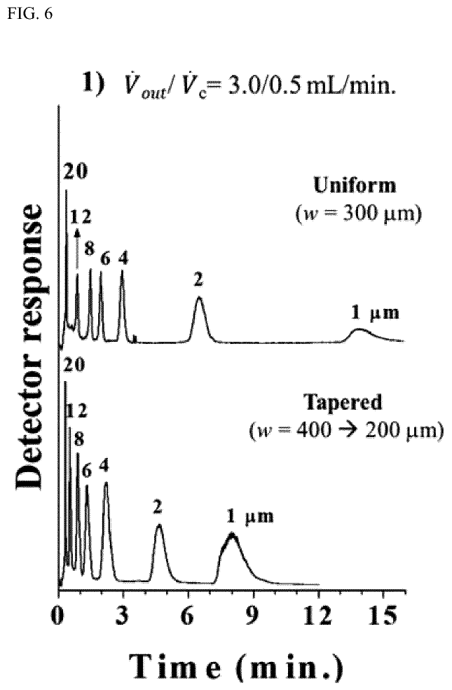

FIG. 5 is a schematic image of a measurement system using a flow field-flow fractionation device.

Polystyrene (PS) standard beads (with diameters of 0.023, 0.051, 0.100, 0.303, 0.400, 0.508, 0.600, 0.799, 0.994, 1.999, 4.000, 6.007, 7.979, 10.15, 12.01, 20.00 μm) were used as samples and evaluation was made. A carrier solution used in the experiment was prepared by adding each of 0.05% sodium dodecyl sulfate (SDS, anionic) and 0.02% sodium azide (NaN₃) purchased from Sigma-Aldrich (St. Louis, MO, USA) to ultrapure water (>18 MΩ·cm). Before executing FlFFF, the solution was filtered using a 0.22 μm pore size mixed cellulose esters (MCE) membrane filter purchased from MF-Millipore (Danvers, MA, USA) through a 2522C-10 vacuum pump (Welch™, Louisiana, USA) and degassed for approximately one hour using a degasser (Branson, Danbury, USA), and then used. As an injector, a model 7725i loop injector (Rheodyne, Cotati, CA, USA) with a loop volume of 25 μL was used, and the carrier solution was delivered into the channels using a model SP930D HPLC pump (Young-Lin Instrument Co., Korea). Sample injection was performed in a focusing/relaxation mode in which the flow rate ratio supplied to the channel inlet and outlet is at a 1:9 so that injected particles were positioned at the 1/10 position from the channel inlet. Samples were detected using a model YL9120 UV-Vis detector at 254 nm, and data was collected using Autochro-3000 software (Young-Lin Instruments Co, Korea).

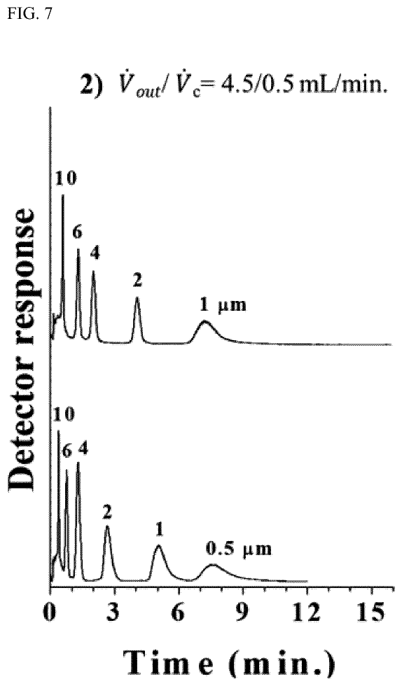

FIGS. 6 and 7 are graphs showing results of comparison of separation of PS standard mixtures, respectively, obtained with a thickness-uniform channel (w=300 μm) and a thickness-tapered channel (w=400→200 μm) under two different flow rate conditions in a steric/hyperlayer mode; (1) \dot{V}ₒᵤₜ/\dot{V}_{c}=3.0/0.5 mL/min and (2) \dot{V}ₒᵤₜ/\dot{V}_{c}=4.5/0.5 mL/min.

FIG. 6 shows polystyrene (PS) separation in a steric/hyperlayer mode of FlFFF obtained with a thickness-uniform channel (w=300 μm, top) and a thickness-tapered channel (w=400→200 μm, bottom) under flow conditions where an outflow rate of the channels is 3.0 ml/min and a crossflow rate thereof is 0.5 mL/min.

Looking at the separation of PS particles in the thickness-tapered channel compared to the thickness-uniform channel, it can be confirmed that the retention time of each particle decreased overall, and the peak intensity for most particles also increased.

In particular, in the case of PS 1.0 μm, the retention time was considerably reduced, which may be expected to indicate that the hydrodynamic lift forces more effectively worked on particles with a long retention time in the thickness-tapered channel.

As shown in FIG. 7, the outflow rate of the channels was increased to 4.5 mL/min so that the flow rate conditions were different from FIG. 6, but the same tendency for the retention time of particles in the thickness-tapered channel to decrease compared to the thickness-uniform channel was exhibited. In addition, PS 0.5 μm particles were successfully separated in the thickness-tapered channel in FIG. 7, which is a result of further increase in the lift forces as the migration flow rate increases.

In addition, since the thickness-tapered channel was thicker at the inlet and thinner at the outlet by 100 μm each compared to those of the thickness-uniform channel, particle migration in the thickness-tapered channel was more sluggish before the half of the channel length but faster in the second half of the channel than in the thickness-uniform channel. Therefore, it was expected that the relaxation and migration of particles would be more stable in the first half of the thickness-tapered channel than the thickness-uniform channel, and it can be confirmed that, due to the steric effect, the separation efficiency of initially eluted particles, such as PS 10 μm in FIG. 6, was maintained.

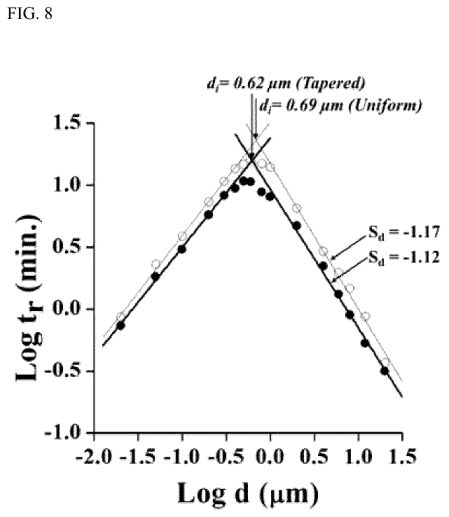

FIG. 8 is a result graph showing steric inversion diameter (dᵢ) values of the thickness-tapered channel and the thickness-uniform channel with log tᵣ(min) versus log d (μm) of PS standard particles.

Steric inversion refers to a phenomenon in which an elution mode is switched, and particles around the steric inversion diameter where this phenomenon occurs have a risk of being eluted together, making it difficult to accurately measure the size of the particles. In order to examine steric conversion in the thickness-tapered channel and the thickness-uniform channel, retention times and diameters of PS standard particles (0.02 to 20 μm) under the flow rate conditions used in FIG. 6 are shown in logarithmic scale in FIG. 8.

As shown in FIG. 8, a slope of a calibration curve (linearly drawn on the right) expressed as diameter-based selectivity S_{d} (=d log tᵣ/d log d) in the steric/hyperlayer mode used data of 1 to 20 μm PS and was calculated as −1.17 and −1.12 for the thickness-uniform channel and the thickness-tapered channel, respectively.

In the normal mode, a calibration curve (linearly drawn on the left) was obtained from data of 0.02 to 0.3 μm PS, and at a crossing point of the two calibration curves, steric inersion diameter values of 0.69 μm and 0.62 μm were obtained for the thickness-uniform channel and the thickness-uniform channel, respectively. Therefore, since the steric inversion diameter values obtained from the two channels were similar, it can be confirmed that even when the thickness at the inlet side of the channel increased, the steric inversion diameter value of the thickness-tapered channel did not significantly change compared to the thickness-uniform channel.

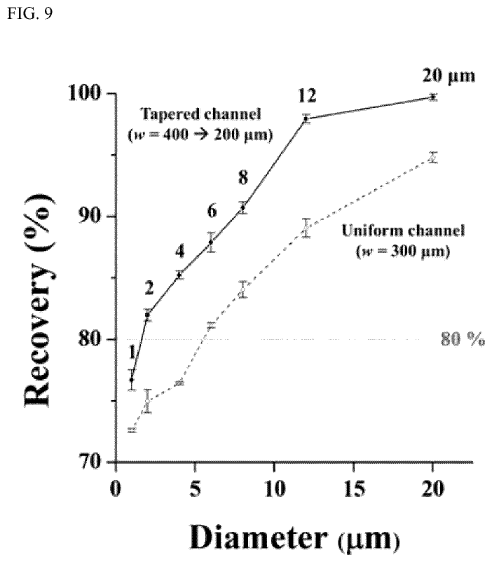

FIG. 9 is a graph comparing recovery rates for PS standard particles in the thickness-tapered channel and the thickness-uniform channel.

As shown in FIG. 9, a typical trend can be confirmed in that a sample recovery rate decreases as the particle size decreases or the retention time increases in the steric/hyperlayer mode.

In addition, it can be confirmed that a recovery rate value was higher in the thickness-tapered channel than in the thickness-uniform channel. The sample recovery rate was obtained by dividing a value obtained by integrating a peak area of each PS standard particle under the flow rate conditions shown in FIG. 6 by a peak area value when there is no crossflow (=field).

In conclusion, because the thickness of the thickness-tapered channel decreases along a channel axis, the channel volume decreases and the migration flow velocity increases toward the outlet. In addition, particles with long retention times (<2 μm) were able to be successfully separated without further increasing the migration flow rate or reducing the crossflow rate with additional equipment such as a flow controller (see FIG. 6).

Therefore, it can be confirmed that, by using the thickness-tapered channel in the steric/hyperlayer mode, the separation time was able to be reduced, sample recovery rate was able to be improved, and flow rate programming effects was able to be exhibited without a separate equipment, thereby allowing a size range of separation to be expanded.

According to one embodiment of the present application, a flow field-flow fractionation channel block can be provided.

According to one embodiment of the present application, a flow field-flow fractionation device can be provided.

According to one embodiment of the present application, a flow field-flow fractionation device capable of increasing separation speed can be provided.

According to one embodiment of the present application, a flow field-flow fractionation device capable of improving a recovery rate of samples can be provided.

According to one embodiment of the present application, a flow field-flow fractionation device capable of exhibiting a flow rate programming effect without separate equipment can be provided.

According to one embodiment of the present application, a flow field-flow fractionation device capable of expanding a separation size range can be provided.

Although the preferred embodiments of the present application have been described above, it is understood that those skilled in the art can make various changes and modifications to the present application without departing from the spirit and scope of the present invention as hereinafter claimed.

What is claimed is:

1. A flow field-flow fractionation channel block comprising:
an inlet through which a fluid is introduced;
an outlet through which the fluid is discharged; and
a channel connecting the inlet and the outlet,
wherein the channel is provided to have a thickness decreasing at least in part along a direction from the inlet to the outlet.

2. The flow field-flow fractionation channel block of claim 1, wherein the channel is provided to have a breadth decreasing at least in part along the direction from the inlet to the outlet.

3. The flow field-flow fractionation channel block of claim 2, wherein the channel includes a first region having a breadth increasing at least in part along the direction from the inlet to the outlet, and
a second region connected to the first region and having a decreasing breadth.

4. The flow field-flow fractionation channel block of claim 3, wherein the second region is provided so that the breadth linearly decreases.

5. The flow field-flow fractionation channel block of claim 3, wherein the channel further includes a third region connecting a second region and the outlet and provided to have a breadth decreasing rate greater than a breadth decreasing rate of the second region.

6. The flow field-flow fractionation channel block of claim 1, wherein the channel is provided so that the thickness linearly decreases.

7. The flow field-flow fractionation channel block of claim 1, wherein the channel is made of polycarbonate.

8. A flow field-flow fractionation device comprising:
a housing having an injection hole and a discharge hole;
the flow field-flow fractionation channel block of claim 1 that is disposed within the housing and includes a channel for transferring a fluid introduced through the injection hole to the discharge hole; and
a membrane disposed within the housing and disposed to allow fluid movement with the channel of the flow field-flow fractionation channel block.
